(19) United States
(12) Patent Application Publication
(10) Pub. No.: US 2018/0339601 A1
(43) Pub. Date: Nov. 29, 2018

(54) CHARGING STATION SYSTEM AND METHOD

(71) Applicant: Martin Kruszelnicki, (US)

(72) Inventor: Martin Kruszelnicki, Santa Monica, CA (US)

(21) Appl. No.: 15/987,689

(22) Filed: May 23, 2018

Related U.S. Application Data
(60) Provisional application No. 62/603,288, filed on May 23, 2017.
(60) Provisional application No. 62/603,945, filed on Jun. 16, 2017.
(60) Provisional application No. 62/603,946, filed on Jun. 16, 2017.

(51) Int. Cl. B60L 11/18

(52) U.S. Cl. CPC B60L 11/1833; B60L 11/1816

(57) ABSTRACT

A charging station system for charging an electric vehicle includes a charging station having a controller configured to control charging of an electric vehicle. The charging station is configured for connection to an MV electrical grid, and the controller is configured to pulse current charge a battery of an electric vehicle operationally engaging the charging station.

### RELATED APPLICATIONS

This application claims the benefit of and priority to U.S. Provisional Application Ser. No. 62/603,288, filed May 23, 2017, U.S. Provisional Application Ser. No. 62/603,945, filed Jun. 16, 2017, and U.S. Provisional Application Ser. No. 62/603,946, filed Jun. 16, 2017, the entire contents of which are hereby incorporated herein by reference.

### BACKGROUND

The present invention relates generally to a charging station. More particularly, the present invention relates to a charging station for an electric vehicle.

Traditional internal combustion engine motor vehicles (e.g., automobiles, trucks, and the like) have dominated transportation for the better part of a century. These traditional internal combustion motor vehicles, however, are powered by fossil fuels (e.g., gasoline). Fossil fuels are known contributors to air pollution and climate change. In recent decades, alternatives to traditional internal combustion engine motor vehicles have arisen (e.g., electric vehicles (“EV”), and gasoline-electric hybrid (“Hybrid”) vehicles) as a way to mitigate climate change, air pollution, and the like. These alternative vehicles use rechargeable batteries to provide power for operation of the alternative vehicle (e.g., moving the vehicle) and powering various systems within the alternative vehicle. Individual batteries may be placed together within a battery pack.

An EV or hybrid battery pack performs the same function as a gasoline tank in a conventional vehicle. That is, the battery pack stores the energy needed to operate the EV or hybrid vehicle. The battery pack can include a number of rechargeable batteries (e.g., Lithium (Li) ion batteries (LIBs), Li-metal polymer batteries (LMPBs), Lithium nickel cobalt aluminum oxide (NCA) batteries, etc.). Gasoline tanks store the energy (i.e., liquid gasoline) needed to drive an internal combustion vehicle 300-500 miles before refilling. In contrast, current generation batteries for EV offer battery capacities for driving only 50-200 miles in affordable electric vehicles, and up to a maximum of 335 miles in expensive luxury electric vehicles.

Different types of charging stations associated with electric and hybrid (e.g., plug-in hybrid) vehicles have been proposed. However, such charging stations have their limitations and can always be improved.

Current charging technology used for fast charging EVs is based on a methodology involving direct current (DC) charging at a constant current/constant voltage (CC/CV). CC/CV charging takes a longer time (i.e., multiples of the amount of time required to fill-up a conventional internal combustion engine vehicle's gas tank with gasoline), and can create excessive heat in the batteries of the EV. Excessive heat in the batteries of an EV can cause accelerated aging of the batteries as well as capacity loss in those batteries. The loss of capacity in the batteries translates into reduced mileage the EV can travel when fully-charged. An EV charging station based on DC fast charging at CC/CV rates can deliver around 125 kW power which, at this power level, requires at least forty-five (45) minutes to recharge just 80% of the vehicle battery's storage capacity. Thus, for EVs to become competitive with internal combustion engine powered vehicles, further reduction is required in charging times of EVs. Therefore, EV DC charging (via CC/CV charging) also has its limitations and EV DC charging can always be improved.

Accordingly, there is a need for an improved charging station for an electric vehicle or a hybrid vehicle. There is also a need for a charging station that provides reduction in charging times. There is a further need for a charging station that can recharge an EV in three (3) to ten (10) minutes in a gas station-like configuration wherein vehicles can circulate in/out in a short time. There is also a need for a new approach to EV charging. There is an additional need for a charging station that is easier to manufacture, assemble, adjust, and maintain. The present invention satisfies these needs and provides other related advantages.

### SUMMARY

The charging station system illustrated herein provides an improved charging station. The charging station system illustrated herein provides an improved charging station system for an electric vehicle or hybrid vehicle. The charging station system illustrated herein provides reduction in charging times. The charging station system illustrated herein provides a new approach to EV charging. The charging station system illustrated herein provides significant recharge of an EV in three (3) to ten (10) minutes in a gas station-like configuration wherein vehicles can circulate in/out in a relatively short time. The charging station system illustrated herein is easier to manufacture, assemble, adjust, and maintain.

A 480V three-phase power supply is a promising technology for the widespread use of EVs. However, current industry strategies (e.g., low voltage and continuous current charging protocols) to achieve fast charging accelerate degradation mechanisms of the battery cells, increase the need for cooling of both the battery packs and the charging cables, and cannot replenish more than 10% of the total range in less than 10 minutes, with the most common recharging period being around 15 minutes (providing only ˜88 miles range). These limitations, for example, can be caused by usage of Lithium battery chemistry that is subject to gassing and overheating at fast recharge rates, vehicle powertrain limitation to a 300-400V nominal voltage architecture, hardware limitation in the cable connectors, and power electronics that interface with the standard electrical grid, usually 480V. Fast charging stations (e.g., such as Level 3 charging (also known as DC fast charging), Combined Charging System (CCS), CHAdeMO (the trade name of a quick charging method for battery electric vehicles delivering up to 62.5 kW of DC (500 V, 125 A) via a special electrical connector), or Tesla Supercharger (120 kW)) experience excessive heat generation during charging, and also require several costly power electronics modules to convert the power from the electrical grid to a useful level for the EV.

Direct connection to a Medium Voltage (MV) Grid (e.g., 5 kV˜35 kV) offers very high-power levels enabling fast and efficient charging of EVs. As disclosed herein, an improved charging station system connects to an MV electrical grid; providing a fast charging capability with a reduced battery recharge time as compared to traditional EV charging systems. An improved charging station is capable of charging EV with nominal voltage of 300-950V with a voltage output of around 1,000V and a current level of around 1,000 amps (A) such that the charging station is capable of outputting 1 MW of power at any given time. For example, an EV capable of receiving charge from the improved charging station includes an electric-powertrain capable of operating at a nominal voltage of 800V and an on-board battery capable of accepting charge at such nominal voltage, and the battery is capable of extreme fast charging/discharging. An improved charging station system can also include a direct connection to the MV electrical grid, power regulation on primary side of a main transformer, simplified power electronics, an automated, optional direct-connected vehicle coupling technology, and optional local energy storage for grid leveling and stabilization.

The charging station can be directly coupled to the EV via a coupling mechanism that electro-mechanically engages a battery interface on the EV. The battery interface on the EV provides a receptacle capable of receiving the 1,000 A continuous current delivered by the charge coupler, and then passed through this direct electro-mechanical connection of the charging station and EV to the EV's battery for charging without needing additional cooling (other than any pre-existing battery cooling system already on-board the EV).

According to another embodiment, an in-ground conductive charge coupler can be used to deliver power from the electric grid to the vehicle/battery. The in-ground conductive charge coupler and the battery interface on the EV can be aligned via an auto-park feature to position the EV over the charge coupler without a user having to exit the EV. In one particular embodiment, the in-ground conductive coupler can plug into a bottom of the EV, with a portion of the charge coupler extending upwards to engage the EV.

According to yet another embodiment, a user can select an up to MV grid connection node (e.g., 5 kV˜35 kV), and a power electronic system for up to 1 MW, high power-factor, low harmonic distortion, AC-DC conversion to charge a battery with 800V and/or 400V and other nominal DC voltages in programmable constant-current and pulse-current modes.

In accordance with another embodiment, an improved charging station can achieve the highest efficiency, highest reliability, and lowest cost step-down for AC voltage by using line-frequency transformers or pulse transformers or other transformer types to bring the AC voltage to an intermediate voltage. In particular, an intermediate voltage of 1-4 kV can be used, depending on design optimization for the power electronics (including active and passive components) of the charging station. At up to 1 MW delivered to the EV, the charging station system provides extremely fast charging of the battery, the highest efficiency, and the lowest cost for a charging station system having such power output.

In an embodiment of the present invention, a pulse charging algorithm is used by a charging station to provide faster charging of an EV battery by utilization of a millisecond charging/discharging method or algorithm instead of a CC/CV charging method. This algorithm provides greater C-rate charging without damaging or prematurely aging battery cells. The pulse charging algorithm described herein allows depolarization of electrodes in the EV battery or battery pack; enabling reduced internal resistance because of removal of polarization component of the resistance. An embodiment of the charging station will have the ability to further accelerate charging using a pulse charging algorithm that defeats the charge polarization component of the battery internal resistance and increase in temperature. As such, replenishment of as much as three hundred fifty (350) miles range in nine (9) minutes can be achieved using the pulse charging algorithm, which is faster than current re-fueling times of any EV and close to the time required to refuel an internal combustion engine automobile. Greater or smaller mileage can be achieved depending on battery chemistry, battery cell configuration, and nominal voltage. For example, 350 miles can be achieved for a 145 kWh battery pack in an EV passenger car.

In an illustrative embodiment, a charging station system for charging an electric vehicle includes a charging station having a controller configured to control charging of an electric vehicle. The charging station is configured for connection to an MV electrical grid, and wherein the controller is configured to pulse current charge a battery of an electric vehicle operationally engaging the charging station.

In a further illustrative embodiment, the charging station further includes an in-ground conductive coupler configured to deliver power from the MV electrical grid to a bottom side of the electric vehicle. There may be another terminal besides two in ground—positive and negative—ground terminal may or may not be used.

In another illustrative embodiment, the charging station is configured to auto-park the electric vehicle over the in-ground conductive coupler for operational engagement with the electric vehicle.

In an additional illustrative embodiment, the in-ground conductive coupler includes at least one charging post movable between stowed and deployed positions, wherein the at least one charging post engages the bottom side of the electric vehicle in the deployed position, and is generally disposed underground in the stowed position.

In a further illustrative embodiment, the charging station further comprises a power electronic system for up to 1 MW power output. Power output may be greater if needed by different size of power electronics or multiplying.

In yet another illustrative embodiment, the power electronic system provides power regulation, AC-DC conversion, and transfer from the MV electrical grid to 800/400V nominal voltage output or whatever nominal voltage output is desired (e.g., there are electric vehicles that have 300-950V systems). A transformer brings AC voltage from the MV electrical grid down to an intermediate voltage comprising a range of 1 to 4kV.

In an illustrative embodiment, the controller is configured to provide a selection of charging modes that includes constant current charging in addition pulse current charging. The controller can also be configured to auto-park an electric vehicle.

In a further illustrative embodiment, the pulse charging is based on a repeating pattern of a high current charge for a plurality of milliseconds, a pause for a plurality of milliseconds, a discharge for a plurality of milliseconds, a pause for a plurality of milliseconds, a high current charge for a plurality of milliseconds.

In another illustrative embodiment, intervals frequency, time of each pattern, time of pause, amount of charge current, and amount of discharge current of the pulse charging are adjusted based on vehicle-specific parameters. The pulse charging may be varied by adjusting one of more of time of charge, time of discharge, and time of pause. The pulse charging may also be varied by adjusting order of charge, discharge and pause in the repeating pattern. The charging station may also provide other charging options (e.g., charging using a constant current charging).

In an additional illustrative embodiment, a method for charging an electric vehicle by a charging station includes establishing communication between the charging station and an electric vehicle. The electric vehicle is positioned by the charging station, and pulse charged.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The various present embodiments now will be discussed in detail with an emphasis on highlighting the advantageous features with reference to the drawings of various embodiments. The illustrated embodiments are intended to illustrate, but not to limit the invention. These drawings include the following figures, in which like numerals indicate like parts:

FIG. 1 illustrates a diagram of a charging station system, in accordance with an embodiment of the present invention;

FIG. 2 illustrates a diagram of a charging station system, in accordance with another embodiment of the present invention;

FIG. 3 illustrates an example of a pulse charging algorithm suitable for accelerated charging of lithium-ion batteries, in accordance with an embodiment of the present invention; and

FIGS. 4A and 4B illustrate an example of multiple EVs using different EV technologies being recharged at the same time by a charging station system using multiple charging stations, in accordance with an embodiment of the present invention.

### DETAILED DESCRIPTION

The following detailed description describes present embodiments with reference to the drawings. In the drawings, reference numbers label elements of present embodiments. These reference numbers are reproduced below in connection with the discussion of the corresponding drawing features.

It is to be understood that the figures and descriptions of the present invention have been simplified to illustrate elements that are relevant for a clear understanding of the present invention, while eliminating, for the purpose of clarity, many other elements found in charging station systems. Those of ordinary skill in the pertinent arts may recognize that other elements and/or steps are desirable and/or required in implementing one or more embodiments of the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the pertinent arts.

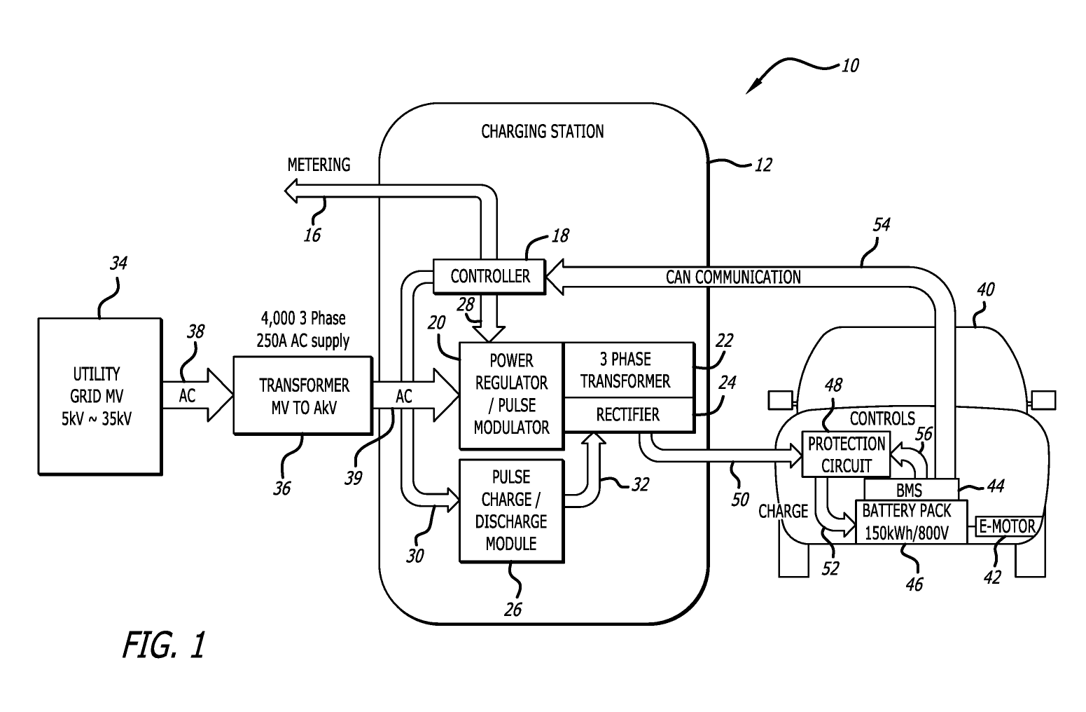

As shown in FIG. 1 for purposes of illustration, an embodiment of the present invention resides in a charging station system 10. The system 10 includes a charging station 12. The charging station 12 is configured to charge EV and hybrid vehicles (e.g., plug-in hybrid vehicles) capable of high power charging and pulse charging, as well as other automotive electric vehicles configured to receive DC fast charge under the Society of Automotive Engineers (SAE) Combo Connector (sometimes referred to as Combined Charging System (CCS)) charging standard (also referred to as SAE CCS), the CHAdeMO standard, and other applicable charging standards.

The charging station 12 includes a central processing unit (CPU) or controller 18 configured to control the operational functions of the charging station system 10. The controller 18 is configured for metering 16. Metering 16 is power measurement that may be used for billing, especially if the MV electrical grid does not include meters. The controller 18 is also configured to manage charging current and voltage. The charging station 12 further includes power electronics that include a power regulator/pulse modulator 20, a three-phase transformer 22, a rectifier 24, and a pulse charge/discharge module 26. The power regulator/pulse modulator 20 functions as a voltage and current regulator (e.g., the power regulator/pulse modulator 20 regulates the MV grid voltage down to 1-4 kV) and regulates current of three phase AC power that flows to the three phase transformer 22. The power regulator/pulse modulator 20 adjusts the amount of power that will go to the batteries/battery pack of the electric vehicle and executes pulse charging of the electric vehicle, as instructed by the controller 18. The three-phase transformer 22 is where the AC power is transformed to lower voltage and higher current, which is then rectified to DC power by the rectifier 24. The three-phase transformer 22 further adjusts the voltage to a desired level, as directed by the controller 18 (e.g., 400V or 800V depending on the battery voltage of the vehicle 40 being charged).

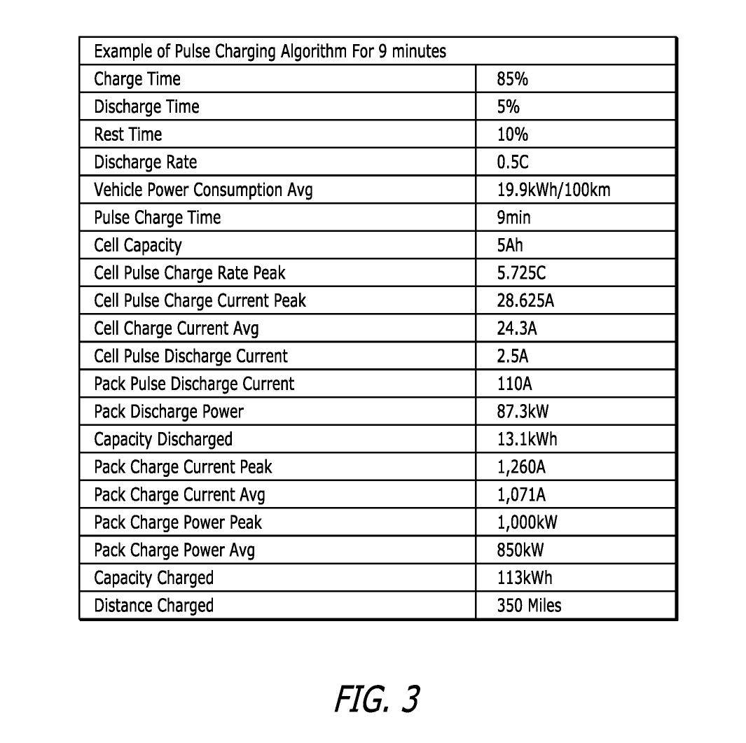

The rectifier 24 is configured to rectify the voltage to the proper threshold to safely charge the vehicle 40. The pulse charge/discharge module 26 is configured to emit pulsed current signals (e.g., as per the pulse charge algorithm of FIG. 3).

The controller 18 is in operational communication 28 with the power regulator/pulse modulator 20, and is also in operational communication 30 with the pulse charge/discharge module 26, and controls the charging of the electric vehicle. For a discharge phase of the pulse charge algorithm of FIG. 3, the energy storage module 144 or load can be used. The energy storage module 144 will be more efficient overall. When the battery pack 46 is being charged, then either the power supply or another battery (e.g., the energy storage module 144 can include a battery with power electronics allowing either release or absorption of energy) provides energy. When the battery pack 46 is being discharged, then load is being applied to the battery pack 46. The pulse charge/discharge module 26 is in operational communication 32 with the rectifier 24. The term “operational communication” may refer to a wired connection, a wireless connection (e.g., Bluetooth™, ZigBee™, Wi-Fi, Wi-SUN, infrared, near field communication, ultraband, or some other short-range wireless communications technology), or a combination thereof. The charging station system 10 may include a communication module (not shown) providing wireless connections between various portions of the charging station system 10, including communication between the charging station 12 and any vehicles 40 being charged.

The charging station system 10 also includes a connection to Utility Grid MV (e.g., 5 kV˜35 kV) 34, and a transformer 36. AC 38 flows from the Utility Grid MV 34 to the transformer 36. The transformer 36 transforms MV to AkV and serves as a 4000 Three Phase 250 A AC supply. The AC 39 leaving the transformer 36 then flows to the charging station 12 and, in particular, the power regulator pulse modulator 20. The charging station 12 is configured to charge one or more vehicles 40 (each vehicle 40 having at least one battery) that require periodic re-charging (e.g., an EV or hybrid vehicle). The vehicle 40 receiving the charge from the charging station 12 has an electric powertrain capable of operating at a nominal voltage of 800V and an on-board battery capable of accepting charge at such nominal voltage. The vehicle 40 also includes a battery interface (e.g., an electro-mechanical receptacle) that can create a direct connection to a mating interface of the charging station 12 (e.g., a coupling mechanism (not shown)) that can deliver 1,000 A continuous current or a pulse current to the battery pack 46 for charging without needing additional cooling other than the battery cooling system existing on-board the EV 40. The coupling mechanism for charging the vehicle 40 can include charging cables that having connectors that include, but are not limited to, Level 3 standard SAE CCS connectors, ChaDeMo connectors, and any Level 4 standard plug. The EV 40 includes at least one electric motor (or E-motor) 42, a battery management system (BMS) 44, a battery pack 46, and a protection circuit 48.

In connection with the operation of the vehicle 40, the BMS 44 performs various tasks including, but not limited to, monitoring of the voltage of the individual battery cells within the battery pack 46, and balancing the battery cells within the battery pack 46. The BMS 44 also monitors the state of charge of the battery pack 46, and performs a state of health calculation. The BMS 44 also monitors the temperature of the battery cells within the battery pack 46. The BMS 44 may include a computing device that can store information in a memory accessible by one or more processors, including instructions that can be executed by the one or more processors. The memory can also include data that can be retrieved, manipulated or stored by the processor. The memory can be of any non-transitory type capable of storing information accessible by the one or more processors, such as a solid state hard drive (SSD), disk based hard-drive, memory card, ROM, RAM, DVD, CD-ROM, Blu-Ray, write-capable, and read-only memories. The instructions can be any set of instructions to be executed directly, such as machine code, or indirectly, such as scripts, by the one or more processors. In that regard, the terms “instructions,” “application,” “steps,” and “programs” can be used interchangeably herein. The instructions can be stored in a proprietary or non-proprietary language, object code format for direct processing by a processor, or in any other computing device language including scripts or collections of independent source code modules that are interpreted on demand or compiled in advance. Data may be retrieved, stored or modified by the one or more processors in accordance with the instructions. For instance, although the subject matter described herein is not limited by any particular data structure, the data can be stored in computer registers, in a relational or non-relational database as a table having many different fields and records, or XML documents. Moreover, the data can comprise any information sufficient to identify the relevant information, such as numbers, descriptive text, proprietary codes, pointers, references to data stored in other memories such as at other network locations, or information that is used by a function to calculate the relevant data. The controller 18 is in operational communication with the BMS 44 such that data including, but not limited to, the state of charge of the battery pack 46, temperature of the battery pack 46, and the like is shared with the controller 18.

The protection circuit 48 receives electrical power (e.g., 1000V/1000 A DC) 50 from the rectifier 24. The electrical power 50 passes through the protection circuit 48 and then provides charge 52 to the battery pack (e.g., 150 kWh/800V) 46. The protection circuit 48 detects any high voltage leaks (i.e., high voltage can not leak into chassis ground or ground of the charging station 12), detects any over—under voltages, over and under temperatures, and other conditions. The protection circuit 48 works with the BMS 44. Depending on the make/model of EV, the protection circuit 48 may sometimes be a part of the BMS 44 and sometimes the protection circuit 48 is separate from the BMS 44. The BMS 44 is in operational communication 54 with the power regulator pulse modulator 20, and provides Controller Area Network (CAN) communication with the controller 18. CAN is a communication standard used in motor vehicles. CAN can be used to communicate with the charging station system 10 but, in the alternative, other standards may be used including wireless communication of any kind. The communication line 54 orders the charging station 12 to deliver a certain amount of power that the BMS 44 will allow to charge the batteries of the battery pack 46 with, and shares other information (e.g., temperature, current, voltage, state of charge, state of health of the battery, overheating, overcharging, charge is complete/incomplete, start and end of charge, etc.). The operational communication 54 between the BMS 44 and the power regulator pulse modulator 20 may be wired or wireless (e.g., a wireless connection may be provided by a communication module (not shown)). The BMS 44 is also in operational communication 56 with the protection circuit 48, and communicates information (e.g., temperature, current, voltage, state of charge, state of health of the battery, overheating, overcharging, charge is complete/incomplete, start and end of charge, etc.).

The charging station system 10, described above, provides connection an MV grid 34, a power electronic system for up to 1 MW; high power-factor, low harmonic distortion; and alternating current to direct current (AC-DC) conversion to charge batteries with 800 V and/or 400 V nominal DC voltages in programmable constant current and pulse-current modes.

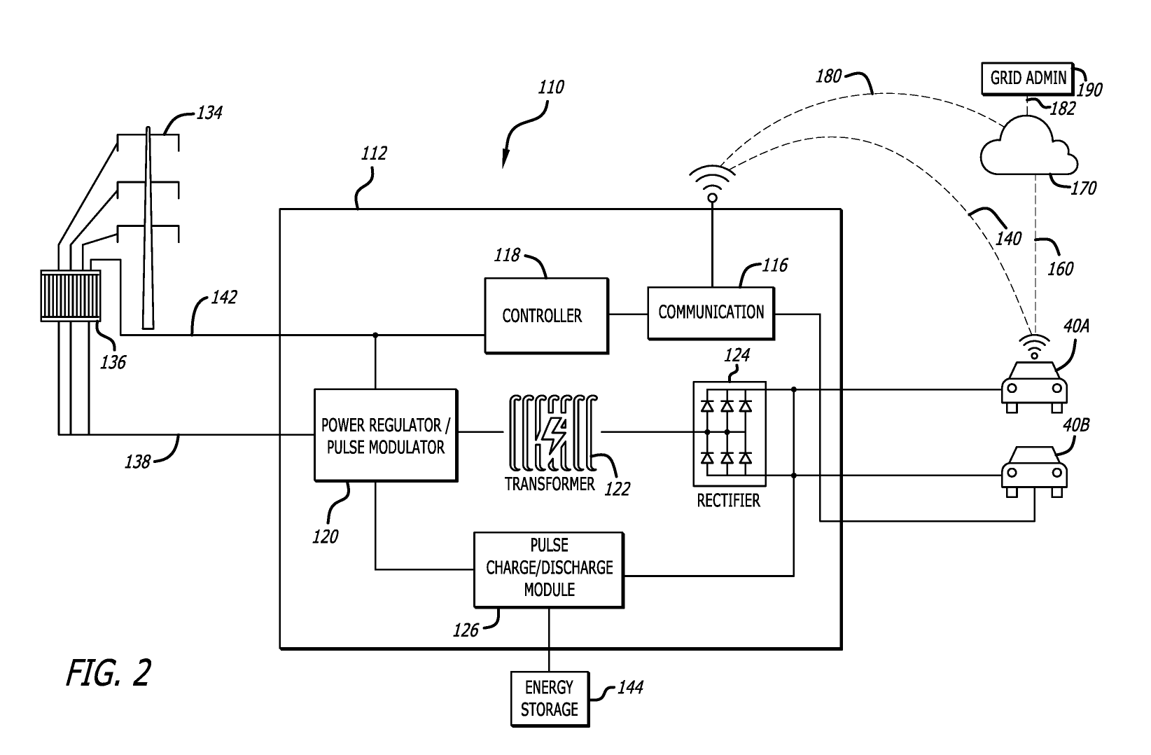

As shown in FIG. 2 for purposes of illustration, another embodiment of the present invention resides in a charging station system 110. The system charging station 110 is similar to the charging station system 10, described above, with the functions of various components of each charging station system 10, 110 being similar (if not identical) to the functions of corresponding components in the other charging station system 110, 10. The charging station system 110 includes a charging station 112. The charging station 112 includes a communication module 116, and a controller 118 configured to control the operational functions of the charging station system 110. The controller 118 is used to manage charging current and voltage as directed by communications coming through the communication module 116, and provides feedback through the communication module 116, if not in direct communication with other components of the charging station system 110. The communication module 116 translates data from the electric vehicle and orders the controller 118 to operate the power electronics per vehicle demand. Communication between the controller 118 and the communication module 116 may include, but are not limited to, voltage, current, temperature, and the like. The controller 118 receives charging/discharging parameters through the communication module 116. The communications module 116, over a wireless link connection (e.g., Bluetooth™, ZigBee™, Wi-Fi, Wi-SUN, infrared, near field communication, ultraband, or some other short-range wireless communications technology), communicates with a vehicle 40 (and the BMS 44 of the vehicle 40) in proximity to the charging station 12. The charging station system 110 may include two ranges of wireless communication: short range, and long range. The short or close proximity range (e.g., Wi-Fi, Bluetooth or other short range) provides wireless communication anywhere from one (1) to five hundred (500) feet of the charging station 112, and preferably within approximately 100 feet of the charging station 112. The long range wireless communication can be provided by wireless technologies that include, but are not limited to, cellular, GPRS, 4G, 5G, LTE, or the like. Specific examples of information transmitted from the vehicle 40 to the controller 118 include, but are not limited to, battery voltage, state of charge, battery internal resistance, battery temperature, power demand, battery state of health, amount of charge required, charging current, VIN number, error codes if any, software version, charging algorithm (e.g., CC/CV, pulse charge, etc.), driving habits, planned driving distance and other.

The charging station 112 further includes a power regulator/pulse modulator 120, a three-phase transformer 122, a rectifier 124, and a pulse charge/discharge module 126. The power regulator/pulse modulator 120 functions as a voltage regulator (e.g., the power regulator/pulse modulator 120 regulates the MV grid voltage down to 1-4 kV) and regulates current of three phase AC power that flows to the three phase transformer 122. The power regulator/pulse modulator 120 regulates power (current) at high voltage on a primary side of the coil of the transformer 122. For example, 1 MW will be 250 A and 4000V—to regulate 250 A is much easier; generating less heat, allowing for use of smaller elements, and providing more efficiency than 1000 A and 1000V which is 1MW, too.

The three-phase transformer 122 is where the AC power is transformed to lower voltage and higher current, and then rectified to DC power in a rectifier 124 (e.g., a Vienna rectifier). The station 112 is configured to charge EV and hybrid vehicles (e.g., plug-in hybrid vehicles) capable of high power charging and pulse charging, and other automotive electric vehicles configured to receive DC fast charge under the SAE CCS standard, the CHAdeMO standard, and other applicable charging standards. The three-phase transformer 122 further adjusts the voltage to a desired level dictated by the controller 118 (e.g., 400V or 800V depending on the battery voltage of vehicle 40A, 40B being charged).

The rectifier 124 is used to rectify the voltage to the proper threshold to safely charge the vehicle 40A, 40B. The pulse charge/discharge module 126 is configured to emit pulsed current signals (e.g., as per the pulse charge algorithm of FIG. 3).

The controller 118 is in operational communication with the power regulator/pulse modulator 120, and is also in operational communication with the pulse charge/discharge module 126. In addition to running pulse charge algorithm of FIG. 3, the controller 118 can run constant current charging, terminate charging, and generally control the process of charging the electric vehicle. Different electric vehicles may have different algorithms for charging (i.e., charging algorithms based on the unique characteristics of a particular make/model of electric vehicle). The controller 118 has that data and can be updated wirelessly at any time. The controller 118 can also communicate all charging information from every charging session (including but not limited to, vehicle information like VIN, mileage, state of charge, etc.). The pulse charge/discharge module 126 is in operational communication with the rectifier 124. The term “operational communication” may refer to a wired connection, a wireless connection, or a combination thereof. The wireless connection may be provided by the communication module 116.

As with the system 10, the system 110 also includes a connection to a Utility Grid MV (e.g., 5 kV˜35 kV (preferably 32.5 kV) 134, and a transformer 136 connected to the grid 134. AC flows from the Utility Grid MV 134 to the transformer 136. The transformer 136 transforms MV to AkV and serves as a 4000 Three Phase 250 A AC supply. Power regulation is on a primary side of the transformer 136 with power electronics. A signal 142 runs from the transformer 136 to the primary side of the transformer power electronics. The signal 142 regulates power. The signal 142 is a message that goes to power regulation elements based on Silicon Carbide (SiC) or other compound and works similar to a digital potentiometer (e.g., it regulates current flow and/or voltage and/or causes pulse. The AC 138 (e.g., 1-4 kV) leaving the transformer 136 then flows to the charging station 112 and, in particular, the power regulator/pulse modulator 120.

The transformer 122 may be optional as long as the transformer 136 can convert the MV grid power to a voltage acceptable by the rectifier 124. The charging station 112 can be dual voltage from one transformer with dual windings or two transformers can be used or a combination thereof. In an example, if the transformer 136 includes a single-winding, and the rectified voltage will be 800V, then another transformer will be required to provide 400V. If the transformer 136 includes a dual-winding, the transformer 136 will provide both voltages from a single assembly. Depending on battery type, only one transformer with 1000V can charge a variety of batteries with different nominal voltages. The rectifier 124 can be a Vienna-type rectifier (which allows some power regulation) or a regular rectifier.

The charging station 112 is configured to charge one or more vehicles 40A, 40B (each vehicle 40A, 40B having at least one battery) that requires periodic re-charging (e.g., an EV or hybrid vehicle). The vehicles 40A, 40B have similar/identical internal components as described above in connection with the vehicle 40 of FIG. 1. The vehicle 40A represents a 800V powertrain EV, and the vehicle B represents a 400V powertrain EV. The vehicle 40A represents an “Ultra Charger” scenario where the protection circuit 48 of the vehicle 40A receives electrical power (e.g., 250V-1000V DC/50 A-1000 A) from the rectifier 124. The vehicle 40B represents an “L3/L4” scenario where the protection circuit 48 of the vehicle 40B receives electrical power (e.g., 250V-450V DC/50 A-800 A) from the rectifier 124. The electrical power passes through the protection circuit 48 and then provides charge to the one or more batteries (e.g., in a battery pack). As discussed above, the protection circuit 48 works with the BMS 44. The operational communication between the BMS 44 and the power regulator/pulse modulator 120 may be wired or wireless (e.g., a wireless connection may be provided by a communication module 116). For example, the vehicle 40A is illustrated as being in direct wireless communication 140 with the communication module 116 of the charging station 112 or, alternatively, as being in indirect wireless communication with the communication module 116 of the charging station 112. Indirect wireless communication from the vehicle 40A to the communication module 116 of the charging station 112 involves the vehicle 40A being in wireless communication 160 with a Network 170, which then wireless communicates 180 with the communication module 116. Either way, the communication module 116 then communicates with the controller 118 which, in turn, then communicates with the power regulator/pulse modulator 120. Wireless communication 160, 180 between vehicle 40A and the charging station 112 (via Network 170) allows the charging station 112 to prepare or reserve charging time for the vehicle 40A. Preparation includes power demand, communication with a grid administrator 190 (via Network 170) and preparation of grid energy storage or an energy storage module 144 (if installed; the energy storage module 144 being optional). The energy storage module 144 is connected to the pulse charge/discharge module 126. The grid administrator 190 (e.g., a power company, or whoever controls the local power grid) can direct power into different areas. When the charging station 112 puts a load on the power grid, the grid administrator 190 can stabilize the power grid by engaging another energy storage close by. The energy storage module 144 can release energy back to the power grid upon grid administrator demand and when certain conditions are met (e.g., conditions including, but not limited to, state of charge, state of energy storage, temperature, number of faults, etc.). During discharge mode of the pulse charging, the energy storage module 144 absorbs discharge from a vehicle's battery or battery pack. When the electric vehicle battery pack is in discharge mode of the pulse charging algorithm, the energy storage module 144 is being charged and absorbs energy from the vehicle battery pack 46. Alternatively, load can be used as power resistor or other. Also, when the vehicle 40A approaches the charging station 112, the grid administrator 190 can prepare for the anticipated load on the power grid. The charging station 112 is in operational communication with the grid administrator 190 through the Network 170, which is in operational communication 182 with the grid administrator 190.

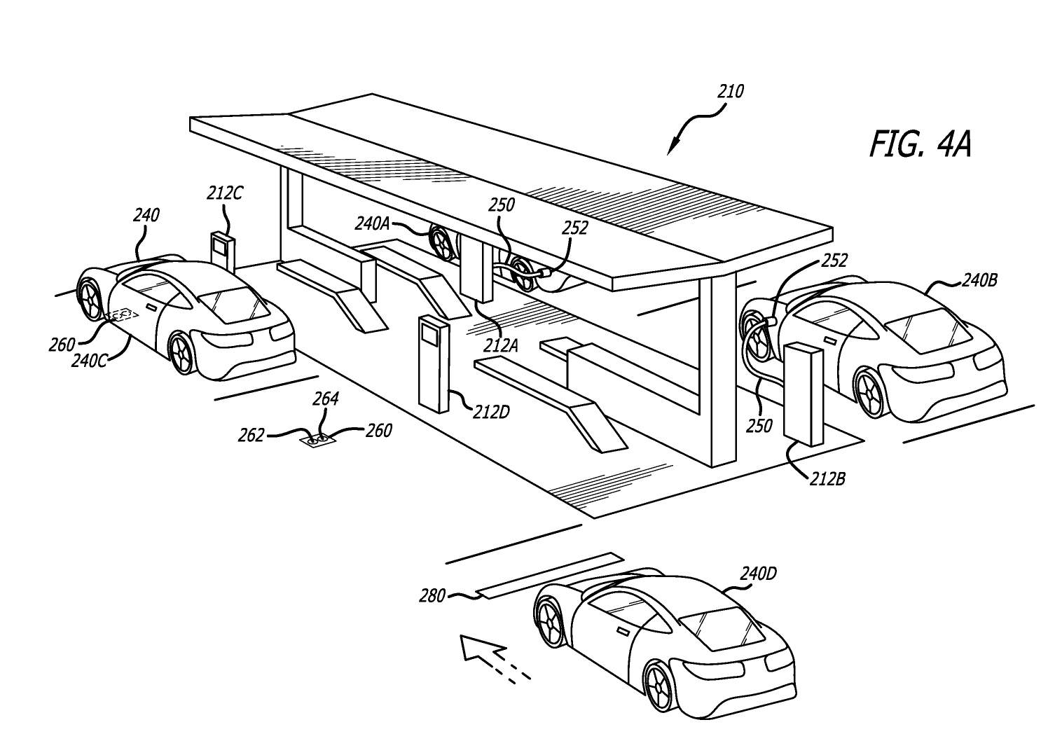

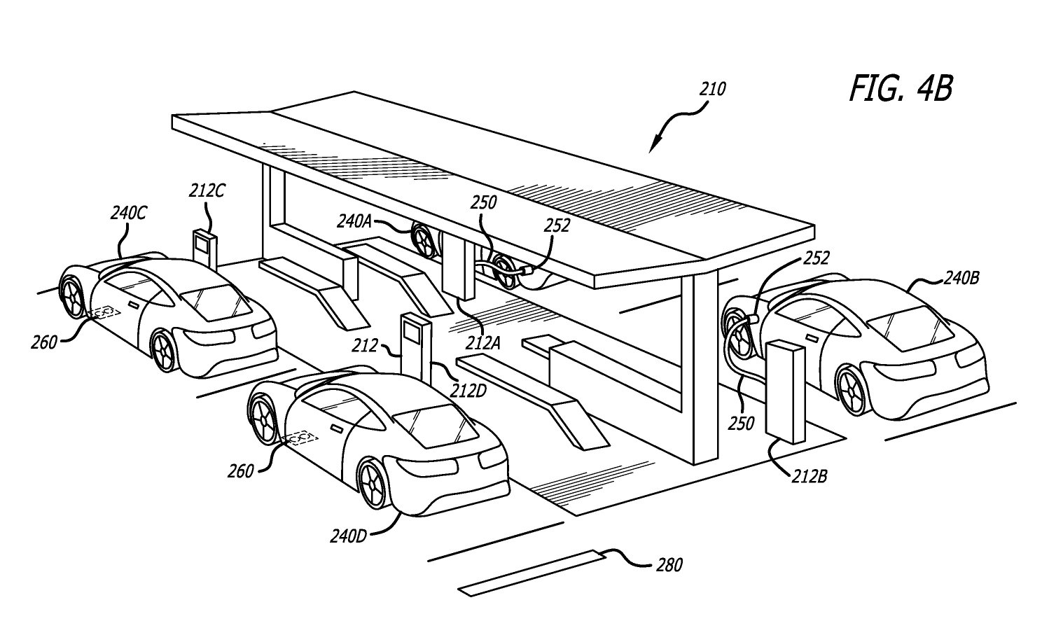

As discussed above, the charging station 12, 112 includes a direct connection to the MV grid 34, 134, and additional energy storage 144 for grid stabilization or to leverage local renewable energy generation or both. The charging station 12, 112 may work as a bi-directional grid power regulator where energy is stored from the MV grid 34, 134 at low demand hours and energy is pushed back into the MV grid 34, 134 during peak demand hours. In addition, the local energy storage 144 may be used to support charging peak demands. For example, in the charging station system 210 of FIGS. 4A and 4B, in the event where four (4) vehicles 240A-D have a need for fast charging at power level above 350 W each, then the local energy storage 144 can be used by the charging station system 10, 110, 210 to offset some of the power demands. The energy storage module 144 will release power and charge batteries of the battery pack 46 using energy stored in storage or will assist the electric grid 134 by putting less load on the electric grid 134. The energy storage module 144 will then be slowly recharged when there is low power demand or energy price from the grid administrator 190.

The charging station 12, 112 provides only DC charging but is able to provide vehicles with charging options (e.g., CC/CV, pulse charging, or a combination thereof). Any cable and connecting standard can be used for charging (e.g., SAE COMBO, CHAdeMO; an in-ground connector able to be engaged to/disengaged from the vehicle 40 either autonomously or manually; or the like). For example, an in-ground connector, such as an in-ground conductive charging coupler, can be used to deliver power from the electric grid to the vehicle/battery with an auto-park feature to position an EV 40 over the charging coupler without a user having to exit the vehicle. The auto-park feature may involve the charging station system 10, 110 taking direct control over the vehicle 40 or providing instructions to the vehicle's own autonomous driving system for parking the vehicle 40 in position over an in-ground connector. Alternatively, the auto-park feature may involve the charging station system 10, 110 taking direct control over the vehicle 40 or providing instructions to the vehicle's own autonomous driving system for parking the vehicle 40 in position near an appropriate charging coupler that requires manual engagement to/disengagement from the vehicle 40. In one particular embodiment, the in-ground conductive coupler can plug into a bottom of the EV. This charging coupler may have more than two terminals as there may be ground-coupling required, or combination of a high-power charge coupler and regular J1772 plug or other standard for communication and ground may be used. Wired and/or wireless communication between the charging station 12, 112 and the vehicle 40 allows a user to be select an up to MV grid connection node (e.g., 5 kV˜35 kV), and a power electronic system for up to 1 MW, high power-factor, low harmonic distortion, AC-DC conversion to charge a battery with 800 V and/or 400 V nominal DC voltages in programmable CC/CV and/or pulse charging modes.

As seen in FIGS. 1 and 2, the charging stations 12, 112 may represent only a single charging station or multiple charging stations at the same location operating within the overall charging station system 10, 110. If there are multiple charging stations 12, 112 at a single location, some of the components (e.g., power regulator/pulse modulator 20, 120; pulse charge/discharge module 26, 126; transformer 22, 122; etc.) seen in the charging stations 12, 112, of FIGS. 1 and 2 may be found within each charging station 12, 112 while other components (e.g., controller 18, 118; communication module 116 (not shown in FIG. 1); etc.) may be physically separate from each charging station 12, 112 but in communication (e.g., wired; wireless; etc.) therewith.

With regard to FIGS. 1 and 2, the controller 18, 118 is configured for wired and/or wireless communication with the vehicles 40 being charged. The communication is used to carry out various functions including, without limitation, communicating with a particular vehicle 40 coming into communications range with the charging system 10, 110; determining the charging standard appropriate for the particular vehicle 40; confirming the charging standard appropriate for the particular vehicle 40; providing a user (e.g., driver of the vehicle 40, or alternatively, the on-board autonomous driving system of the vehicle 40) with a choice of charging modes (e.g., CC/CV mode; a pulse charging mode; etc.); confirming the charging mode selected by the user; warning the user if the charging mode selected by the user is not appropriate or recommended for that vehicle 40; providing instructions/data to the vehicle 40 for autonomously parking the vehicle 40 by a particular charging station 12, 112 that is available and/or suitable for charging the particular vehicle 40; providing information to the driver of the vehicle 40 regarding which charging station 12, 112 is available/appropriate for the particular vehicle 40 if the driver desires to manually park the vehicle 40; engaging the vehicle 40 to a coupling mechanism (e.g., a charging cable, an in-ground coupler configured to engage an underside of the vehicle 40, etc.) used to electrically connect the vehicle's batteries or battery pack to the charging station 12, 112 (if the coupling mechanism does not require manual connection to the vehicle 40 by the user); determining if a particular charging coupler appropriate to the vehicle 40 has made proper electrical connection with the vehicle 40 in order to safely energize the appropriate charging coupler at start of charge; charging the vehicle 40 using the charging mode selected by the user; monitoring the charging during the charging process; determining the end of charge; safely terminating charging; and disengaging the coupling mechanism from the vehicle 40 (if the coupling mechanism does not require manual disconnection from the vehicle 40 by the user). As seen in FIGS. 4A and 4B, more than one vehicle 40 may be re-charging at any particular time, and the controller 18, 118 is able to carryout concurrent charging of multiple vehicles 40. The controller 18, 118 may include a computing device that can store information in a memory accessible by one or more processors, including instructions that can be executed by the one or more processors. The memory can also include data that can be retrieved, manipulated or stored by the one or more processors. The memory can be of any non-transitory type capable of storing information accessible by the one or more processors, such as a solid state hard drive (SSD), disk based hard-drive, memory card, ROM, RAM, DVD, CD-ROM, Blu-Ray, write-capable, and read-only memories. The instructions can be any set of instructions to be executed directly, such as machine code, or indirectly, such as scripts, by the one or more processors. In that regard, the terms “instructions,” “application,” “steps,” and “programs” can be used interchangeably herein. The instructions can be stored in a proprietary or non-proprietary language, object code format for direct processing by a processor, or in any other computing device language including scripts or collections of independent source code modules that are interpreted on demand or compiled in advance. Data may be retrieved, stored or modified by the one or more processors in accordance with the instructions. For instance, although the subject matter described herein is not limited by any particular data structure, the data can be stored in computer registers, in a relational or non-relational database as a table having many different fields and records, or XML documents. Moreover, the data can comprise any information sufficient to identify the relevant information, such as numbers, descriptive text, proprietary codes, pointers, references to data stored in other memories such as at other network locations, or information that is used by a function to calculate the relevant data. The charging station 12, 112 may include a user interface (e.g., a graphical user interface) allowing a user to manually set charging of the electric vehicle 40 (e.g., identifying the make/model of vehicle to be charged; selecting a charging mode (e.g., CC/CV, pulse charging, etc.); providing a method of payment (e.g., cash; credit card; debit card; cryptocurrency; “gas card”; etc.); and otherwise inputting information relevant to the charging which may be prompted by the charging station 12, 112 as per instructions programmed into the controller 18, 118. Individual users (e.g., drivers, vehicle owners, or the like) and/or vehicles 40 may be registered with the charging station system 10, 110, 210, with information regarding the users, vehicles 40 and the like being stored in databases.

As seen in FIG. 3, an example of a pulse current charging (or pulse charging) algorithm is provided that is suitable for accelerated charging of Lithium ion batteries (e.g., Lithium batteries based on Nickel, Cobalt, Manganese Oxide cathodes). This pulse current charging algorithm is beneficial in allowing shorter recharge times and allowing higher recharge rates by diminishing the polarization component of the battery cells internal resistance and limiting the amount of heat generated during fast charge.

The pulse current charging algorithm is used by a charging station 12, 112 to provide much faster charging of an EV battery by utilization of the millisecond charging/discharging pulse charging algorithm instead of a CC/CV charging method. The pulse current charging algorithm provides greater C-rate charging without damaging or prematurely aging battery cells. The C-rate is a measure of the rate at which a battery is being discharged, and is defined as the discharge current divided by the theoretical current draw under which the battery would deliver its nominal rated capacity in one hour. For example, a 1 C discharge rate would deliver the rated capacity of a battery in one (1) hour, and a 2 C discharge rate means it will discharge twice as fast (i.e., in a half (0.5) hour). In theory, a 1 C discharge rate on a 1.6 Ah battery translates to a discharge current of 1.6 A, and a 2 C rate translates to a discharge current of 3.2 A. The pulse charging algorithm described herein allows depolarization of electrodes in the EV battery or battery pack; enabling reduced internal resistance because of removal of polarization component of the resistance. The pulse charging algorithm accelerates charging as the pulse charging algorithm defeats the charge polarization component of the internal resistance of the batteries/battery pack 46, and accelerates charging as the pulse charging algorithm reduces heat generation during charging. Depolarization causes less resistance, and less resistance translates into less heat and more energy that can be absorbed.

The illustrative pulse charging is based on a repeating pattern of a milliseconds high current charge, a pause for a period of time (e.g., milliseconds), a milliseconds discharge, a pause for a period of time, a milliseconds high current charge algorithm. In this manner, the pulse charging may be based on a repeating pattern of a high current charge for a plurality of milliseconds, a pause for a plurality of milliseconds, a discharge for a plurality of milliseconds, a pause for a plurality of milliseconds, and a high current charge for a plurality of milliseconds. Variables such as intervals frequency, time, pause, charge current, and discharge current are adjusted based on vehicle-specific parameters including, but not limited to, battery state of charge, temperature, power demand, and the like. As discussed above, the vehicle 40 is in operational communication with the charging station 12, 112 by wired and/or wireless connection. The operational communication between the vehicle 40 and the charging station 12, 112 allows the aforementioned vehicle-specific parameters of any particular vehicle 40 to be communicated from the vehicle 40 and factored into the charging of that particle vehicle 40. The charging station 12, 112 is able to monitor the charging of that particular vehicle 40. Communication can be in only one direction (i.e., from the vehicle 40 to the charging station) or, depending on the make/model of the particular vehicle 40, bi-directional (i.e., the charging station is also able to communicate information to the vehicle 40). The particular embodiment illustrated in FIG. 3 is but one example. All parameters of the pulse charging algorithm are adjustable depending on vehicle-specific parameters (such as those previously mentioned). In another illustrative example, the pulse charging algorithm is as follows: a thirty (30) milliseconds 5 C rate charge, a five (5) millisecond pause, a ten (10) millisecond 2 C rate discharge, a five (5) millisecond pause, and a thirty (30) millisecond 5 C rate charge. The charging pattern repeats until charging is complete.

As described above, there is flexibility to the algorithm. For example, the time of charge, the time of discharge, and/or the time of pause can be varied, individually or in combination. Also, alternating between charge, discharge and pause can also be varied, individually or in combination, as seen in the following examples: (1) charge, discharge, pause; (2) charge, pause, discharge; (3) discharge, charge, pause; and (4) discharge, pause, charge.

As seen in FIGS. 4A and 4B for purposes of illustration, another embodiment of the present invention resides in a charging station system 210 that can accommodate multiple electric vehicles 240 (e.g., four (e) electric vehicles 240A-D) being recharged at the same time. Each of the electric vehicles may be different makes and models of EVs from one another (and thus use different EV battery technologies, or use different charging couplers). The electric vehicle 240 may have similar/identical internal components as those described above in connection with the vehicle 40 of FIG. 1 such that the charging station system 210 is configured to operationally communicate with the electric vehicles 240A-D through a wired connection, wireless connection, or a combination of both wired/wireless connections. The charging station system 210 illustrates four (4) individual charging stations 212A-D (similar, if not identical, to the charging stations 12, 112) such that the four (4) electric vehicles 240A-D may be charged at the same time (one electric vehicle 240A-D per charging station 212A-D). Alternatively, each charging station 212A-D may be designed as a dual-charging station such that each charging station 212A-D is able to accommodate two (2) electric vehicles positioned on opposite sides of the dual-charging station. However, each charging station system 210 may be designed according to the needs of where the charging station system 210 is located such that the charging station system 210 may include only a single charging station or up to as many charging stations as the geographic size of the location upon which the charging station system 210 is situated will allow (similar to the manner in which a conventional gas station includes a number of individual gasoline pumps for handing a certain number of internal combustion vehicles filling-up with gasoline given the size of the gas station's location). While only EVs are illustrated as being charged in FIGS. 4A and 4B, plug-in hybrid vehicles (not shown) could also be charged at the charging station system 210.

For purposes of illustration, two of the vehicles 240A, 40B seen in FIGS. 4A and 4B are being charged at nominal voltage of 400V with a Level 3 charging power (e.g. 50 kW). Each vehicle 240A, 240B uses a different type of charge coupler and/or the charging coupler 250 connects to a different portion of the vehicle 240A, 240B as the vehicles 240A, 240B are different makes/models. In addition to the first two vehicles, an additional two vehicles 240C, 240D are shown being charged at 800V nominal voltage with a power level in excess of 350 kW. The total power level may not exceed 1 MW for the illustrated charging station system 210.

The EV 240C, 240D are each being charged by respective separate in-ground conductive couplers 260 in electro-mechanical communication with the charging station 212 to deliver electrical power from the electrical grid 34, 134 to the batteries/battery pack 46 of each EV 240C, 240D. An auto-park feature positions each EV 240C, 240D over its respective coupler 260 without the driver of the EV having to exit the vehicle, as the in-ground coupler automatically plugs into or otherwise electrically engages a battery interface on the bottom of the EV 240C, 240D. In the alternative, each EV 240C, 240D may be manually aligned with a respective coupler 260 by an on-board guidance system that includes a camera and display to show alignment of the vehicle's battery interface with the coupler 260. The in-ground coupler 260 is configured such that a connecting portion of the in-ground coupler 260 move upwards to plug into or otherwise electrically engage the receptacle such that electrical charge may be transferred to the batteries/battery pack 46. The in-ground coupler 260 is disposed underground, with a top of the in-ground coupler generally planar with the ground surface. In one embodiment, the connecting portion of the in-ground coupler 260 moves upwards to electro-mechanically engage the vehicle 240C, 240D, and includes two cylindrical charging posts 262, 264 configured such that each post 262, 264 is configured for linear actuation up and down for charging the EV 240C, 240D. The charging posts 262, 264 are movable between stowed and deployed positions. The charging posts 262, 264 engage the bottom side of the electric vehicle 240C, 240D in the deployed position, and are generally disposed underground in the stowed position. The vehicle 240C, 240D is positioned to properly target the charging posts 262, 264 and engage in charging once a safe and low resistance connection is made between the vehicle 240C, 240D and the in-ground coupler 260. The coupler 260 is connected to the electrical power bus through two power blocks (not shown), one per each of the posts 262, 264. Such power blocks create a link between the electrical wires leaving the rectifier 24, 124 that carry electricity to the cylindrical posts 262, 264. Each post 262, 264 includes a contact pad made of a durable material capable of withstanding weather and dirt exposure and grant low contact resistance electrical connection with the in-vehicle battery interface. Alternatively, the coupler 260 includes a single cylindrical post capable of moving up and down through a linear mechanical actuator and of positioning itself in full contact with the charging receptacle of the vehicle 240C, 240D.

In use, the charging station system 10, 110, 210 operates when an EV 40 comes within proximity of a charging station 12, 112. Proximity to the charging station 12, 112 includes, without limitation, geographic proximity, wireless communications range, or the like. A user (e.g., a driver) of the EV 40, 240 can initiate communication with the charging station system 10, 110, 210 (e.g., by pressing a button within the EV 40, 240 or otherwise taking action to initiate wireless communication with the charging station system 10, 110, 210 including, but not limited to setting controls within the EV 40 such that the EV 40 is configured to automatically seek out wireless communication with a particular or any charging station system 10, 110, 210 within a certain proximity). Alternatively, controls within the charging station system 10, 110, 210 may be configured such that the charging station system 10, 110, 210 is configured to automatically seek out wireless communication with a particular EV 40, 240 (e.g., an EV 40, 240 that is registered with the charging station system 10, 110, 210) or any EV 40, 240 within a certain proximity of the charging station system 10, 110, 210 such that the user (or EV 40, 240 if configured to do so) can accept/decline wireless communication with the charging station system 10, 110, 210; etc.).

Communication between the charging station system 10, 110, 210 and the EV 40, 240 allows the charging station system 10, 110, 210 to determine information relevant to charging (e.g., charge of the batteries/battery pack of the EV 40, 240; temperature of the batteries/battery pack of the EV 40, 240; make/model of the EV 40, 240; charging parameters of the EV 40, 240; the type of interface(s) on the EV 40, 240 available for charging; the presence of an autonomous parking/driving system on the EV 40, 240, and whether the autonomous parking/driving system is compatible with the charging station system 10, 110, 210 such that the EV 40 240 can be guided to a particular charging station 12, 112, 212; payment information (e.g., credit card; debit card; “gas card”; or an account registered with the charging station system 10, 110, 210); etc.).

The EV 40, 240 is positioned in close proximity to a particular charging station 12, 112, 212. The EV 40, 240 can be manually positioned in close proximity to the particular charging station 12, 112, 212 by the user parking the EV 40, 240 next to that charging station 12, 112, 212. Alternatively, the EV 40, 240 can auto-park itself next to the particular charging station 12, 112, 212 due to communication between the EV 40, 240 and the charging station system 10, 110, 210 (e.g., by the charging station system 10, 110, 210 providing parking instruction to the EV 40, 240 with regard to a particular charging station 12, 112, 212; by the charging station system 10, 110, 210 taking control of the EV 40, 240 to auto-park the EV 40, 240 next to a particular charging station 12, 112, 212; etc.).

The EV 40, 240 and the charging station system 10, 110, 210 remain in operational communication by wired and/or wireless connection, and the charging station system 10, 110, 210 monitors vehicle-specific parameters including, but not limited to, battery state of charge, temperature, power demand, and the like. At some point, the charging station system 10, 110, 210 has made connection with a MV grid (e.g. 5 kV˜35 kV) in preparation for charging the EV 40, 240.

The user selects a desired charging mode (e.g., CC/CV, pulse charging, etc.). The charging mode can be manually selected by the user at the charging station 12, 112, 212 via a user interface (e.g., a graphical user interface that may include a touchscreen for selection of displayed options or a screen displaying options associated with particular buttons on the charging station 12, 112, 212; etc.). Alternatively, the desired charging mode can be manually selected by the user on a user interface within the EV 40, 240 (e.g., a graphical user interface that may include a touchscreen for selection of displayed options or a screen displaying options associated with particular buttons within the EV 40, 240; etc.). In the alternative, if the EV 40, 240 is registered with the charging station system 10, 110, 210, a preferred charging mode (along with other preferences (e.g., payment)) may be stored in the charging station system 10, 110, 210, and automatically selected by the charging station system 10, 110, 210. Once the charging mode is selected, the charging station system 10, 110, 210 configures the charging station 12, 112, 212 to charge the EV 40, 240 according to the selected charging mode, via an appropriate charging mechanism (e.g., charging cable; in-ground connector; etc.) associated with the charging station 12, 112, 212.

As discussed above, the charging station 12, 112, 212 includes one or more charging cables 250. If the EV 40, 240 is to be charged using a charging cable, the user plugs an appropriate charging cable 250 (e.g., a charging cable associated with the make/model of the EV 40, 240) into a mating receptacle 252 located on the EV 40, 240 for receiving electrical charge. The mating receptacle 252 is in electro-mechanical communication with the batteries/battery pack 46. The controller 18, 118 determines there is proper electro-mechanical engagement of the charging cable 250 and mating receptacle 252, monitors, and/or adjusts charging of the batteries/battery pack 46 during the charging process.

In the alternative, the EV 40, 240 may be configured for being charged by an in-ground conductive coupler 260 in electro-mechanical communication with the charging station 12, 112, 212 to deliver electrical power from the electrical grid 34, 134 to the batteries/battery pack 46. An auto-park feature positions the EV 40, 240 over the coupler 260 so that the in-ground coupler 260 may be aligned a battery interface or receptacle (not shown) on the bottom of the EV 40, 240. As seen in FIG. 4A, one vehicle 240C is already positioned over a coupler 260, and the other vehicle 240D is positioned by a starting line 280 (either manually by the driver of the vehicle or by other means such as an autonomous driving system). The charging station system 210 then positions the vehicle 240D over the coupler 260, aligning the coupler 260 with the battery interface/charging receptacle on the bottom of the vehicle 240D, as seen in FIG. 4B. The in-ground coupler 260 is configured such that the cylindrical posts 262, 264 of the in-ground coupler 260 move upwards to plug into or otherwise electro-mechanically engage the battery interface/charging receptacle on the bottom of the vehicle 240D such that electrical charge may be transferred to the batteries/battery pack 46. The controller 18, 118 determines there is proper electro-mechanical engagement of the charging coupler 260 and EV 240C, 240D, monitors, and/or adjusts charging of the batteries/battery pack 46 during the charging process.

The charging station system 10, 110, 210 charges the vehicle 40, 240 until the controller 18, 118 indicates the batteries/battery pack 46 have been charged. Once charging is complete, the vehicle 40, 240 is electro-mechanically disengaged from the charging station 12, 112, 212. Data regarding the completed charging can be exchanged between the charging station system 10, 110, 210 and the vehicle 40, 240 during and/or after charging. Once charging is complete, payment can be made for that charging by prompting the driver for a method of payment or recording the transaction with an account registered to the driver of the vehicle for subsequent invoicing/payment.

Although the present invention has been discussed above in connection with use on an electric or hybrid automobile, the present invention is not limited to that environment and may also be used on other fully-electric or hybrid vehicles including, but not limited to, space vehicles, buses, trains, carts, carriages, and other means of transportation.

Likewise, the present invention is also not to be limited to use in vehicles and may be used in non-vehicle or stationary environments (e.g., machinery, mining, elevators, or any device where electrical power is required and there is no constant energy supply). Furthermore, the present invention is also not to be limited to use in connection with electric vehicles, and may be used in any environment where electrical power is required.

In addition, the claimed invention is not limited in size and may be constructed in miniature versions or for use in very large-scale applications in which the same or similar principles of energy charging and/or storage as described above would apply. Likewise, the dimensions of the charging station system is not to be construed as drawn to scale, and that the dimensions of the charging station system may be adjusted in conformance with the area available for its placement. Furthermore, the figures (and various components shown therein) of the specification are not to be construed as drawn to scale.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “front,” “rear,” “left,” “right,” “inner,” “outer,” “beneath”, “below”, “lower”, “above”, “upper,” “horizontal,” “vertical” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The above description presents the best mode contemplated for carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above that are fully equivalent. Consequently, this invention is not limited to the particular embodiments disclosed. On the contrary, this invention covers all modifications and alternate constructions coming within the spirit and scope of the invention as generally expressed by the following claims, which particularly point out and distinctly claim the subject matter of the invention.

What is claimed is:

1. A charging station system for charging an electric vehicle, comprising:
a charging station including a controller configured to control charging of an electric vehicle; wherein the charging station is configured for connection to an MV electrical grid, and wherein the controller is configured to pulse current charge a battery of an electric vehicle operationally engaging the charging station.

2. The charging station system of claim 1, wherein the charging station further comprises an in-ground conductive coupler configured to deliver power from the MV electrical grid to a bottom side of the electric vehicle.

3. The charging station system of claim 2, wherein the charging station is configured to auto-park the electric vehicle over the in-ground conductive coupler for operational engagement with the electric vehicle.

4. The charging station system of claim 2, wherein the in-ground conductive coupler includes at least one charging post movable between stowed and deployed positions, wherein the at least one charging post engages the bottom side of the electric vehicle in the deployed position, and is generally disposed underground in the stowed position.

5. The charging station system of claim 1, wherein the charging station further comprises a power electronic system for up to 1 MW power output.

6. The charging station system of claim 5, wherein the power electronic system provides power regulation, AC-DC conversion, and transfer from the MV electrical grid to 800/400V nominal voltage output.

7. The charging station system of claim 5, wherein a transformer brings AC voltage from the MV electrical grid down to an intermediate voltage comprising a range of 1 to 4 kV.

8. The charging station system of claim 1 wherein the controller is configured to provide a selection of charging modes that includes constant current charging in addition pulse current charging.

9. The charging station system of claim 1, wherein the controller is configured to auto-park an electric vehicle.

10. The charging station system of claim 1, wherein the pulse charging is based on a repeating pattern of a high current charge for a plurality of milliseconds, a pause for a plurality of milliseconds, a discharge for a plurality of milliseconds, a pause for a plurality of milliseconds, a high current charge for a plurality of milliseconds.

11. The charging station system of claim 1, wherein intervals frequency, time of each pattern, time of pause, amount of charge current, and amount of discharge current are adjusted based on vehicle-specific parameters.

12. The charging station system of claim 1, wherein the pulse charging may be varied by adjusting one of more of time of charge, time of discharge, and time of pause.

13. The charging station system of claim 1, wherein the pulse charging may be varied by adjusting order of charge, discharge and pause in the repeating pattern.

14. A method for charging an electric vehicle by a charging station, comprising:
establishing communication between the charging station and an electric vehicle;
positioning the electric vehicle by the charging station; and
pulse charging the electric vehicle.
